(19) United States
(12) Patent Application Publication
(10) Pub. No.: US 2007/0260436 A1
(43) Pub. Date: Nov. 8, 2007

(54) System and method for evaluating system architectures

(75) Inventors: Jerry M. Couretas, Arlington, VA (US); Vee P. Adrounie, Fairfax Station, VA (US); John H. Hammond, Fairfax, VA (US)

Correspondence Address: OLIFF & BERRIDGE, PLC, P.O. BOX 19928, ALEXANDRIA, VA, 22320, US

(73) Assignee: LOCKHEED MARTIN INTEGRATED SYSTEMS AND SOLUTIONS, (US)

(21) Appl. No.: 11/411,839

(22) Filed: Apr. 27, 2006

(51) Int. Cl. G06G 7/48

(52) U.S. Cl. 703/6

(57) ABSTRACT

Aspects of the invention can provide a system and method for evaluating system architectures that can include a system architecture design device that creates a system architecture having at least one system architecture variant, a simulation system that performs multiple warfighting simulations using the system architecture in a same scenario while varying the at least one system architecture variant, and a post processor that evaluates warfighting outcomes of the multiple simulations that correspond to different system architecture variants. Further, the system architecture design component can create the system architecture to include at least one of an intelligence, surveillance, reconnaissance (ISR) and strike architecture, as well as a characteristic of sensors and interceptors that can include at least one of an aerial, space based, sea borne, land based and subterranean device.

### BACKGROUND

Combining platform models into system architectures and simulating military outcomes has traditionally been used as an ancillary decision support tool for procurement. As such, system architectures and simulation have often acted as a compliment to subjective decision making, instead of as a guide. With technology risk being the key driver in the most prior Department of Defense (DoD) acquisitions, procurement officials and contractors often had a challenge in simply making devices meet desired mission specifications. As a result, “simulation” consisted mainly of physics-based evaluation tools used to predict individual system performance.

While in the past, these physics-based models were the primary guides to military component assessments, eventually, they were replaced with statistical descriptions that led to the “system-of-systems” or system architecture concept. As a by-product, candidate DoD contracts with proven technologies now make offerings based on system architectures, which are an ensemble, or component grouping, of available technologies.

### SUMMARY

In the 1996 Clinger-Cohen Act, Congress imposed a policy level requirement that legally required government contractors to use the Department of Defense Architecture Framework (DoDAF) to document system architecture design concepts. While the DoDAF's goal is to mitigate integration risks, computing a system architecture's utility remained a subjective exercise. For example, modeling and simulation's contributions as a training tool have no analog for illuminating system procurement decisions. Reasons for this include: 1) system performance and interaction estimates, such as model inputs, are bounded by the modeler's understanding; 2) scenarios vary widely in terms of red and blue tactical unit expected behavior; and 3) architecture space enumeration (e.g., design of the experiments) is usually performed by the modeler's “best guess” as to the scenario/architecture composition and the associated sensitivities involved.

Aspects of the invention can provide a method and technique for evaluating DoDAF architectures via an agent based mission/campaign warfighting simulation model. More particularly, aspects of the invention can provide a database system architecture depiction tool that is used to create agent models that make up a system architecture. These system architectures and their simulations can be leveraged to provide an effectiveness simulation of the corresponding system architecture. These combinations can be valued in terms of system architecture “goodness” when proposing a mission capability. The access, via graphical user interface, to agent based models through the system architecture depiction tool results in systems design and intelligent planning, coordinated with contemporary transformational procurement processes, that previous agent based models and their respective simulations could not provide.

Additionally, aspects of the invention can provide a validated agent based mission/campaign warfighting simulation model that can be used for quick turnaround simulation/evaluation of DoDAF architecture products. For example, the invention can include a database system architecture automated depiction tool, and intelligent methodology to create agent models to generate high level operational effectiveness for warfighting missions/campaigns.

Aspects of the invention can provide a system and method for evaluating system architectures that includes creating a system architecture having at least one system architecture variant, performing multiple warfighting simulations using the system architecture in a same scenario while varying the at least one system architecture variant, and evaluating warfighting outcomes of the multiple simulations that correspond to the system architectures having the different system architecture variants. The system architecture can be at least one of an intelligence, surveillance, reconnaissance (ISR), and strike architecture.

Aspects of the system and method for evaluating system architectures can further include a system architecture variant that includes a characteristic of sensors and interceptors that are at least one of an aerial, space based, sea borne, land based, and subterranean device.

Further, in the system and method for evaluating system architectures, the system architecture can be created by a Popkin SA architecture interface, the multiple simulations can be performed by a system evaluation and analysis simulation (SEAS), and the step of creating a system architecture having at least one system architecture variant can be performed by the Popkin SA architecture interface to produce a set of system architecture products that complies with a Department of Defense Architecture Framework (DoDAF).

### BRIEF DESCRIPTION OF THE DRAWINGS

The preferred embodiments of the present invention will be described with reference to the following drawings, wherein like numerals designate like elements, and wherein:

FIG. 1 is an exemplary input-output block diagram of a simulation system in accordance with the invention;

FIG. 2 is a block diagram of an exemplary system for evaluating system architectures;

FIG. 3 is a chart showing a plot of exemplary results output from a system for evaluating system architectures;

FIG. 4 is a chart showing a plot of exemplary results output from a system for evaluating system architectures; and

FIG. 5 is a flowchart outlining an exemplary operation of a system that evaluates system architectures.

### DETAILED DESCRIPTION OF EMBODIMENTS

As described above, aspects of the present invention can provide a system and method for evaluating system architectures that is capable of directly mapping system architectures to measures of effectiveness (MOEs) that are intuitive to a warfighting customer. Specifically, aspects of the invention can directly map DoDAF system architectures to MOEs which can be readily evaluated. Examples of MOEs can include, but are not limited to, monetary cost, system performance, time to completion of a mission/campaign, and risk.

Aspects of the present invention can evaluate DoDAF system architectures via an agent-based mission/campaign warfighting simulation model. For example, the invention can be used to evaluate the use of space-based imagery systems or other integrated intelligence, surveillance, and reconnaissance (ISR) systems with various mission scenarios. Such methodology can use government validated government off-the-shelf (GOTS) agent-based warfighting simulation technology to roll up the man-machine interface commercial off-the-shelf (COTS) technology combination that characterizes most military missions/campaigns and their associated scenarios. Accordingly, COTS/GOTS tools can be leveraged to provide ISR system architectures. Further, the present invention can therefore enable judgment of each aggregate system architecture in terms of warfighter/consumer value.

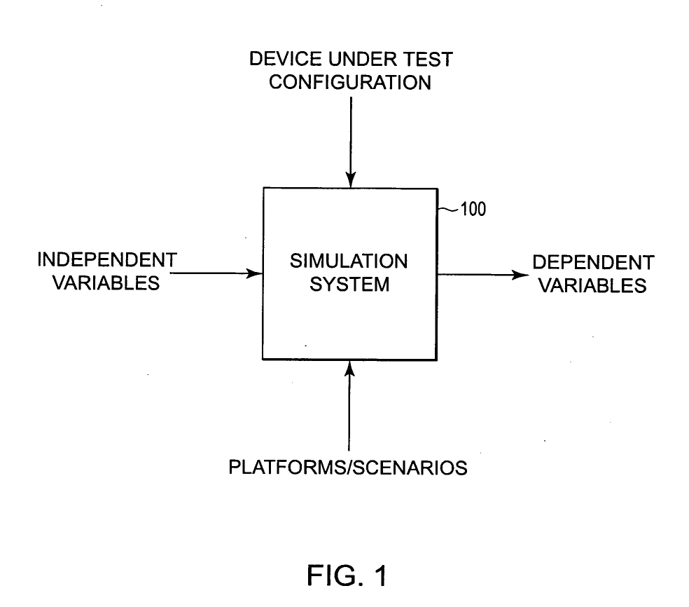

FIG. 1 shows an exemplary input/output diagram of a simulation system 100 in accordance with the invention. As shown, the simulation system 100 can receive numerous inputs, perform a simulation based on the inputs, and output a result. For example, the input to the simulation system 100 can include platforms and scenarios, independent variables, and device under test (DUT) configurations. Further, as shown, the output can be in the form of dependent variables, since the output is dependent on the above-described inputs.

The platforms and scenarios can include data regarding the mission, environment, and conditions under which the simulation is to be performed. For example, the platform information can include data about the devices that populate the scenario, such as the satellites, ships, aircraft, missiles, tanks, troops, and the like. This can include not only capabilities of the devices, but also relationships between the devices, such as communication and coordination with and between the individual devices. Additionally, the platforms can include a characterization of the intelligence, surveillance and reconnaissance devices that are part of the mission/campaign.

The scenario information can include data about the mission/campaign. Such data can include mission objective information, target information, enemy force information, geographical or terrain information, weather information, and the like. Additionally, the scenarios can include strike characterization information that includes the type of strike platform (e.g., manned vs. unmanned), estimated platform constraints for the mission, and accuracy assumptions for payload packages. The scenarios can include descriptive information that ranges from individual engagements and campaigns to multiple theater warfighting evaluations.

The independent variables can include the number of devices, such as air and space assets, that are to be utilized in the simulation. Further, the independent variables can include a metric with which the simulator is to run the simulation. Additionally, the independent variables can include data on the tacticalitheater sensor and imagery exploitation time constraints to evaluate information processing time-lags on system warfighting effectiveness.

The device under test configuration can include information collectors, collector configurations, and exploitation time assumption for collector information. These time assumptions are essentially due to back office (e.g., call centers are a common analog) queuing systems that prescribe the amount of time it takes to process raw collector data into useful information products.

The dependent variables can include data, such as the targets killed, the number of sensor detections, blue force losses, time duration of the engagement, and the like.

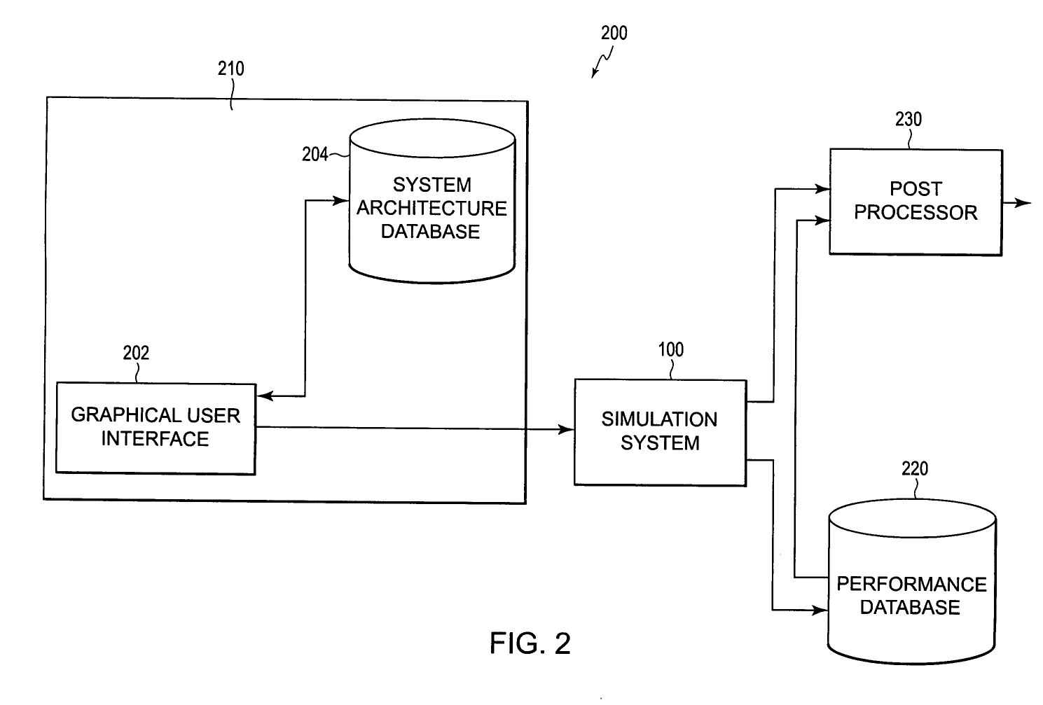

FIG. 2 shows an exemplary system for evaluating system architectures 200. The system for evaluating system architectures 200 can include a system architecture design component 210, a simulation system 100, a performance database 220, and a post processor 230. The system architecture design component 210 is coupled to the simulation system 100 for transmitting system architectures designed by the system architecture design component 210 to the simulation system 100. Once the simulation system 100 has completed a simulation based on a system architecture, the results of the simulation can be transmitted to either one or both of the performance database 220 and/or the post processor 230.

Of course, it should be understood that a portion, all, or multiple system architectures can be transferred from the system architecture design component 210 to the simulation system 100. Further, the system may transmit a portion, all, or multiple simulation results to one or both of the performance database 220 or post processor 230.

As shown in FIG. 2, the system architecture design component 210 includes a graphical user interface (GUI) 202 that can be coupled with a system architecture database 204. The GUI 202 is a device, such as a software program running on a computer, that is used to create a system architecture that is to be transmitted to the simulation system 100. The GUI 202 allows a user to intuitively set-up or assemble components of a system architecture and create desired interconnections or relationships between the components to create a complete system architecture for subsequent evaluation.

The system architecture database 204 can be a pre-stored library of system architectures or components of system architectures, as well as relationships or interconnections between the components of the system architectures. Further, the system architecture database 204 can store previously created system architectures or components thereof that the user of the GUI 202 may wish to save for re-use at a later time. By using the pre-stored library of the system architecture database 204 in conjunction with the GUI 202, a user can more rapidly create a system architecture for simulation. This is because the user need not re-create repeatedly used components, such as satellites, or their respective interconnections, such as communication links between the satellites and a ground-based receiving station.

As described above, the simulation system 100 receives the system architecture created by the system architecture design component 210. The simulation system 100 performs a simulation on the system architecture based on a defined scenario. As described above with reference to FIG. 1, the scenario is defined by numerous inputs to the simulation system 100. The results of the simulation can then be transmitted to the performance database 220 and/or the post processor 230.

The performance database 220 can receive the simulation results from the simulation system 100. Results data from the respective simulations can be stored in the performance database 220, with or without the corresponding system architectures. Also, multiple simulation results corresponding to the system architectures can be stored with reference to the respective system architectures, so that the results of the simulations for the various system architectures can be compared relative to each other.

As also shown in FIG. 2, the post processor 230 can receive data from both the simulation system 100 and the performance database 220. The post processor 230 can be any device, such as analysis software running on a computer, capable of aggregating or performing analysis on the results of the simulation. For example, the post processor 230 can be a personal computer running a spreadsheet program that can arrange and graph the results data as desired. Therefore, the results data of the simulation from the simulation system 100 or the performance database 220 can be organized and analyzed. For example, the result data can be aggregated into graphs or other forms so that the results of different simulations can be compared with each other. Accordingly, system architectures can be directly mapped to measures of effectiveness (MOEs) that are intuitive to the customer evaluating the system architecture.

As an example of operation, an exemplary simulation and evaluation of system architectures will now be described with reference to a sea-based power projection scenario. The exemplary scenario in this case is a year 2015˜2020, 24-hour response, hyper-velocity missile deterrent of a rogue nation's mobile tactical ballistic missile (TBM) capability. For the sake of simplicity, only a single variable will be varied between different system architectures to illustrate how the system can evaluate different system architectures.

In this exemplary scenario, exploring the use of existing assets for a limited conflict strike is done with the assets described below in Table 1.

TABLE 1

| Agent Type | Number | Description |
|---|---|---|
| Blue Rattler Ship | 1 | Strike Platform |
| Blue SBR Satellites | (3, 6, 9, 12) | Only source of targeting data |
| Blue Comm | 2 | one for orders and the other |
| Nodes/Channels | | one for target sitings |
| Red TBMs | 120 | Primary Rattler targets |
| Red Confusers | 50 | Trucks, buses used to confuse |
| | | the Rattler targeting system |
| Total | 185 | |

In the sea-based power projection scenario, assets are divided into blue and red assets. Blue assets represent those of the customer, or in this example the U.S. military, while red assets represent those of an opposing or enemy force. As can be seen in Table 1, the blue assets or agents include a Rattler ship which is a strike platform that would be deployed in a relevant theater of the scenario. The blue assets further include satellites imagery collectors and communication nodes/channels. The communication nodes/channels also are included as devices, since these devices are the main technique for coupling the respective entities in a scenario.

In this exemplary scenario, the blue satellites imagery collectors are a system architecture variant, in that the number of satellites can be varied from three to twelve. Thus, by performing simulation on different system architectures having only a different number of satellites, an optimum number of satellites can be determined for this particular scenario. While it is the number of satellites that is varied in this exemplary scenario, it should be understood that any system architecture variant, or number of system architecture variants, can be changed between the different system architectures.

As also shown in Table 1, the red assets or agents include 120 TBMs, which are the primary targets for the Rattler ship in this scenario. The red assets also include 50 “confusers”, such as trucks or buses, that can be used to confuse the targeting system of the Rattler ship.

Initially, the various system architectures for the sea-based power projection scenarios are created with the use of the system architecture design component 210. For example, using a system architecture tool, such as Popkin SA, the different system architectures can be created with the use of the GUI 202 and the system architecture database 204. Specifically, the various red and blue assets can be programmed within the system architectures, as well as the relationships, such as communication and control between the various assets. As described above, the system architectures can be in the DoDAF format.

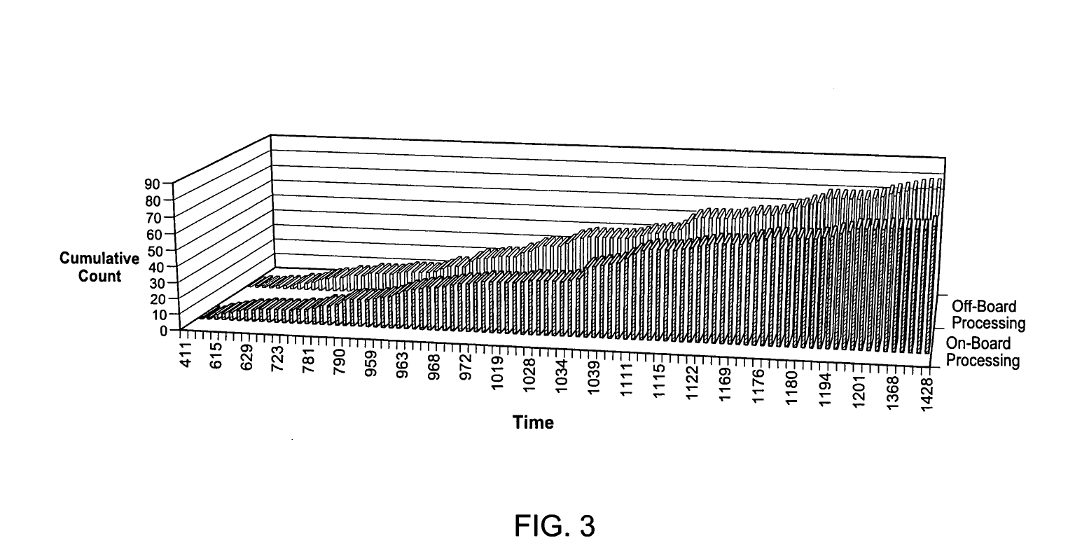

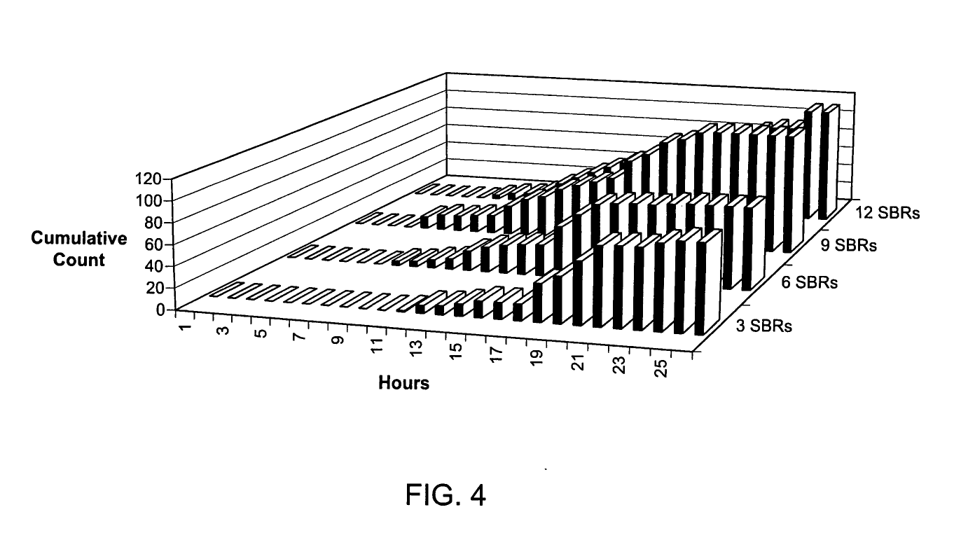

During creation of the system architectures, different system architectures can be created for the different evaluations shown in FIGS. 3 and 4. As described in greater detail below, FIG. 3 shows the results of simulations run on different system architectures where the image processing can be either on or off-board the Rattler ship, while FIG. 4 shows the results of simulations run on different system architectures where the number of SBR satellites is varied between three and twelve.

Once the system architectures have been created, they are transmitted to the simulation system 100, where simulation is performed on the various different system architectures. The simulation system 100 can be a discrete time simulator, such as a systems evaluation and analysis simulator (SEAS). The SEAS simulator can map the different system architectures to outcomes based on the particular scenarios. Further, the SEAS simulator can use the Popkin SA, mainly as a graphical user interface, to enter DoDAF views that describe reconfigurable intelligence, surveillance, and reconnaissance (ISR) system architectures. The data contents of the operational system architecture views can subsequently be used to parameterize the SEAS simulator with a pre-loaded scenario. With such a configuration, multiple simultaneous theater simulations can be run in order to compare/contrast warfighting utility estimates of a range of system architecture alternatives.

After the simulation is performed, the results can be transmitted to either the performance database 220 and/or the post processor 230. The performance database 220 can store the results for subsequent analysis. The post processor 230 can perform evaluation and analysis on the results, such as organization and aggregation of data into a format that can be readily evaluated. The format can include, for example, the graphs shown in FIGS. 3 and 4.

FIGS. 3 and 4 are graphs showing the results of simulations run based on the different system architectures. Specifically, FIG. 3 shows two system architectures each including three satellites, with a first system architecture having the processing of down linked satellite imagery being performed “on-board” the Rattler ship, and a second system architecture having the processing of down linked satellite imagery being performed “off-board” the Rattler ship, such as in a theater Distributed Common Ground System (DCGS).

The graph of FIG. 3 describes the relative performance of the system architectures with on-board versus off-board image processing using a killer victim scoreboard (KVS) to evaluate the number of red TBM launchers destroyed over a 24-hour period. FIG. 3 describes the relative performance of 3 ball satellite imager architecture with on-board vs. off-board image processing using the “killer victim scoreboard” to evaluate the number of red TBM launchers destroyed over a 24 hour period.

FIG. 4 is a graph plotting the simulation results of four different system architectures, where the net KVS gain is measured over time as the number of SBR satellites is varied between three and twelve. Specifically, in this exemplary scenario, the user has control over the number of available SBR satellites which will be the only source of target data.

It should be appreciated from the graph shown in FIG. 4 that the system architecture utilizing an orbitology of nine satellites results in the greatest number of kills from the simulation results. Also, from the results, it can be seen from the graph that the twelve SBR satellite system architecture has saturated the tactical processing station, and is just catching up to the nine SBR satellite system architecture at the end of the 24-hour evaluation period.

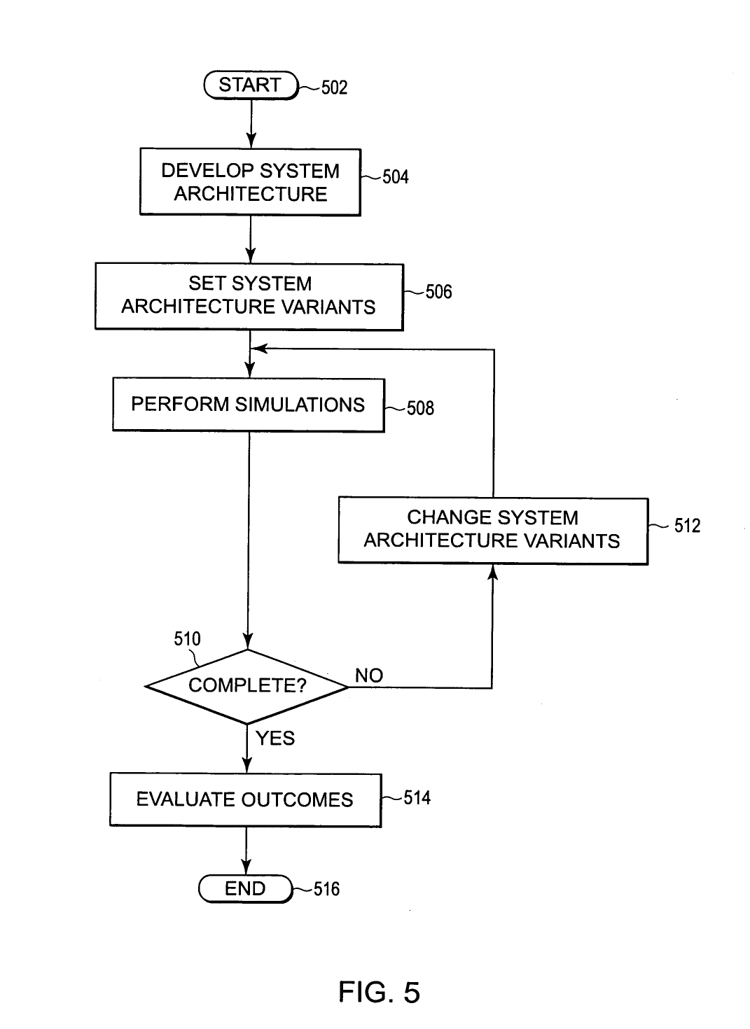

FIG. 5 is a flowchart outlining an exemplary operation of the system for evaluating system architectures. As shown in FIG. 5, the process begins at step 502 and proceeds to step 504. In step 504, a system architecture is developed. As described above, the system architecture can be created using the Popkin SA development tool. Further, the system architecture can be created in accordance with the DoDAF standards.

The process then proceeds to step 506 where system architecture variants are decided and set. The system architecture variant can vary a number of devices, such as satellites, that participate in the system architecture. For example, a number of imaging satellites can be varied in the system architecture, while everything else remains the same.

The process then proceeds to step 508 where simulations are performed. As described above, simulations can be performed on a discrete time simulator, such as a systems evaluation and analysis simulator (SEAS). The SEAS simulator can run simulations of the system architectures based on pre-load scenarios to produce a result outcome.

The process then proceeds to step 510. In step 510, the process determines whether another simulation must be preformed. If no further simulation is to be preformed, then the process proceeds to step 514, otherwise, the process proceeds to step 512.

In step 512, the system architecture variant is changed, so as to alter the system architecture. As described above, the system architecture variants can be a number of devices used in a particular system architecture. For example, as in the scenario associated with FIG. 4, the number of imaging satellites can be varied to see how it affects the outcome of a simulation.

The process then returns to step 508 where another simulation is performed using the system architecture having the modified system architecture variant. After simulation is performed, the process again proceeds to step 510, where a determination is made as to whether an additional simulation needs to be performed. If not, the process then proceeds to step 514.

In step 514, the various result outcomes corresponding to the various different system architectures are evaluated. As described above, the system architectures can be compared using various measures of effectiveness (MOE). Further, in order to more effectively evaluate the outcome results, the MOEs can be placed in a readily evaluated format, such as a graph or chart.

After the outcome results are evaluated in step 514, the process then proceeds to step 516, where it is terminated.

As shown in FIG. 2, the method of this invention is preferably implemented on a programmed processor. However, the system for evaluating system architectures 200 can be implemented on a general purpose or special purpose computer, a programmed microprocessor or microcontroller and peripheral integrated circuit element, ASIC or other integrated circuit, a hardware electronic or logic circuit, such as a discrete element circuit, a programmable logic circuit, such as PLD, PLA, FPGA or PAL, or the like. In general, any device on which a finite state machine capable of implementing the flow chart shown in FIG. 5 can be used to implement the system for evaluating system architectures' 200 functions of this invention.

Further, while this invention has been described with specific embodiments thereof, it is evident that many alternatives, modifications, and variations will be apparent to those skilled in the art. Accordingly, the preferred embodiments of the invention as set forth herein are intended to be illustrative, not limiting. Various changes may be made without departing from the spirit and scope of the invention.

What is claimed is:

1. A system for evaluating system architectures, comprising:
a system architecture design device that creates a system architectures having at least one system architecture variant;
a simulation system that performs multiple warfighting simulations using the system architecture in a same scenario while varying the at least one system architecture variant; and
a post processor that evaluates warfighting outcomes of the multiple simulations that correspond to the system architectures having the different system architecture variants.

2. The system according to claim 1, wherein the system architecture design device creates the system architecture to include at least one of an intelligence, surveillance, reconnaissance, and strike architecture.

3. The system according to claim 1, the system architecture design device creating the at least one system architecture variant to include a characteristic of sensors and interceptors that are at least one of an aerial, space based, sea borne, land based, and subterranean device.

4. The system according to claim 1, the system architecture design device creating the system architecture by a Popkin SA architecture interface.

5. The system according to claim 1, the simulation system performing the multiple simulations with a system evaluation and analysis simulation (SEAS).

6. The system according to claim 1, the post processor warfighting outcomes including calculated warfighting costs that correspond to different system architecture variants.

7. The system according to claim 6, the warfighting costs including at least one of monetary cost, system performance, time to completion, and risk.

8. The system according to claim 6, the warfighting costs including an effect on red and blue tactical units.

9. The system according to claim 1, wherein the system architecture design device creates a system architecture having at least one system architecture variant in accordance with a Department of Defense Architecture Framework (DoDAF).

10. The system according to claim 1, the post processor further including a performance database that stores the warfighting outcomes of the multiple simulations that correspond to the system architectures having the different system architecture variants.

11. A method for evaluating system architectures, comprising:
creating a system architecture having at least one system architecture variant;
performing multiple warfighting simulations using the system architecture in a same scenario while varying the at least one system architecture variant; and
evaluating warfighting outcomes of the multiple simulations that correspond to the system architectures having the different system architecture variants.

12. The method according to claim 11, the system architecture further comprising at least one of an intelligence, surveillance, reconnaissance, and strike architecture.

13. The method according to claim 11, wherein the at least one system architecture variant includes a characteristic of sensors and interceptors that are at least one of an aerial, space based, sea bome, land based, and subterranean device.

14. The method according to claim 11, wherein the system architecture is created by a Popkin SA architecture interface.

15. The method according to claim 11, wherein the multiple simulations are performed by a system evaluation and analysis simulation (SEAS).

16. The method according to claim 11, wherein the step of evaluating warfighting outcomes includes calculating warfighting costs that correspond to different system architecture variants.

17. The method according to claim 16, the warfighting costs including at least one of monetary cost, system performance, time to completion, and risk.

18. The method according to claim 16, the warfighting costs including an effect on red and blue tactical units.

19. The method according to claim 11, wherein the step of creating a system architecture having at least one system architecture variant is performed in accordance with a Department of Defense Architecture Framework (DoDAF).

20. The method according to claim 11, wherein the step of evaluating further includes storing the warfighting outcomes of the multiple simulations that correspond to the system of architectures having the different system architecture variants in a performance database
